(19) United States
(12) Patent Application Publication
(10) Pub. No.: US 2011/0289894 A1
(43) Pub. Date: Dec. 1, 2011

(54) FILTER ELEMENT OF MICROGLASS & NONWOVEN SUPPORT LAYER MEDIA

(75) Inventor: Timothy John Nicholas, Calmore Hampshire (GB)

(73) Assignee: General Electric Company, Schenectady, NY (US)

(21) Appl. No.: 12/789,784

(22) Filed: May 28, 2010

(51) Int. Cl. B01D 46/52

(52) U.S. Cl. 55/486

(57) ABSTRACT

A composite filter element is provided. The composite filter element is configured for filtering fluid. The composite filter element includes a microglass media of glass fibers and a scrim laminated to the microglass media. The scrim is configured to provide support for the microglass media. In one aspect, the composite filter element has a filtration efficiency greater than or equal to about 99.5% for capturing a particle size of about 0.3 microns. In another aspect, a frame is provided that is configured to hold the at least one composite filter element in a V-shaped pocket and a basis weight of the microglass media and the scrim is at least about 90 g/m². In another aspect, the scrim further can withstand approximately 25″ of water gauge pressure without the glass fibers of the microglass media separating from each other.

### BACKGROUND OF THE INVENTION

1. Field of the Invention

The invention relates generally to a filter element, and more particularly, to a composite filter element having a scrim with a microglass media.

2. Discussion of Prior Art

Composite filter elements may be used to provide clean air to various devices. Such devices may include gas turbines. Meltblown materials are sometimes used as the substrate within filter elements. Meltblown materials typically have a static charge. The static charge will decrease over time due to a variety of factors which results in the efficiency of the filter also decreasing over time.

Glass materials are also sometimes used as the substrate in filter elements. Unlike meltblown materials, glass materials do not hold a static charge. However, glass materials have a weaker tensile strength making glass materials undesirable for high-pressure and/or wet (moist/humid) environments. In these environments, it is possible that such glass materials may develop tears and thus experience a reduced filtering ability.

### BRIEF DESCRIPTION OF THE INVENTION

The following summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

One aspect of the invention provides a filtration system including a composite filter element configured for filtering fluid including a microglass media of glass fibers and a scrim deposited on the microglass media. The scrim is configured to provide support for the microglass media, and the composite filter element has a filtration efficiency greater than or equal to 99.5% for capturing a particle size of 0.3 microns.

Another aspect of the invention provides a filtration system including at least one composite filter element for filtering fluid including a microglass media of glass fibers, a scrim laminated to the microglass media, and a frame configured to hold the at least one composite filter element. The scrim is configured to provide support for the microglass media, and a basis weight of the microglass media and the scrim is at least 90 g/m². The frame includes at least one V-shaped pocket that receives the at least one composite filter element.

In accordance with another aspect, the invention provides a filtration system including a composite filter element configured for filtering fluid including a microglass media of glass fibers, and a scrim deposited to the microglass media. The scrim is configured to provide support for the microglass media, where the composite filter element has a filtration efficiency greater than or equal to 99.5% for a particle size of 0.3 microns. The scrim further includes means to withstand approximately 25″ of water gauge pressure without the glass fibers of the microglass media separating from each other.

### BRIEF DESCRIPTION OF THE DRAWINGS

The foregoing and other aspects of the invention will become apparent to those skilled in the art to which the invention relates upon reading the following description with reference to the accompanying drawings, in which:

FIG. 1 is a schematic, cross-sectional illustration of a portion of a composite filter element that includes a microglass media and a scrim in accordance with an aspect of the present invention;

FIG. 2 is a schematic, cross-sectional illustration of a larger amount of the composite filter element shown in FIG. 1 in an example corrugated configuration in accordance with another aspect of the present invention; and

FIG. 3 is a perspective view of an example filter cartridge that includes the composite filter element of FIG. 1 in accordance with another aspect of the present invention.

### DETAILED DESCRIPTION OF THE INVENTION

Example embodiments that incorporate one or more aspects of the invention are described and illustrated in the drawings. These illustrated examples are not intended to be a limitation on the invention. For example, one or more aspects of the invention can be utilized in other embodiments and even other types of devices. Moreover, certain terminology is used herein for convenience only and is not to be taken as a limitation on the invention. Still further, in the drawings, the same reference numerals are employed for designating the same elements. It should be appreciated that the schematic drawings may not be drawn with exact relative dimensions.

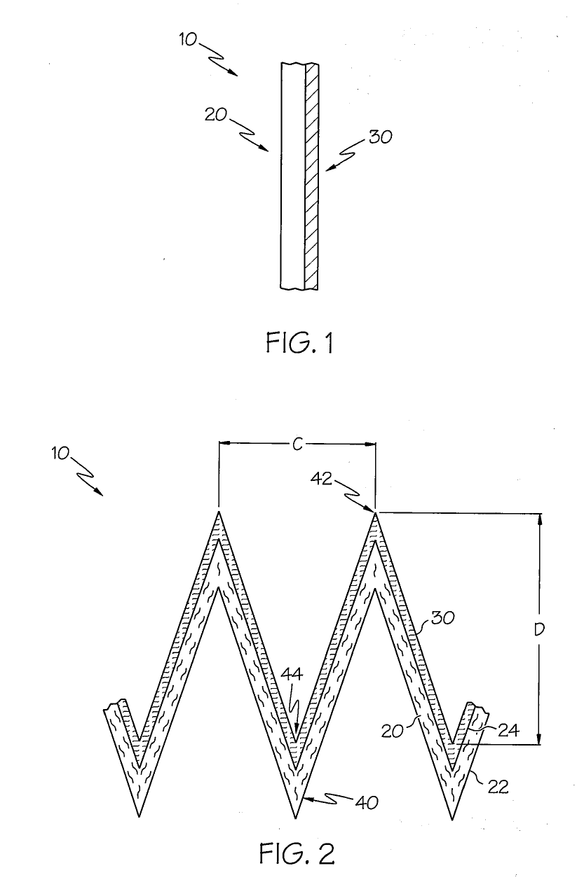

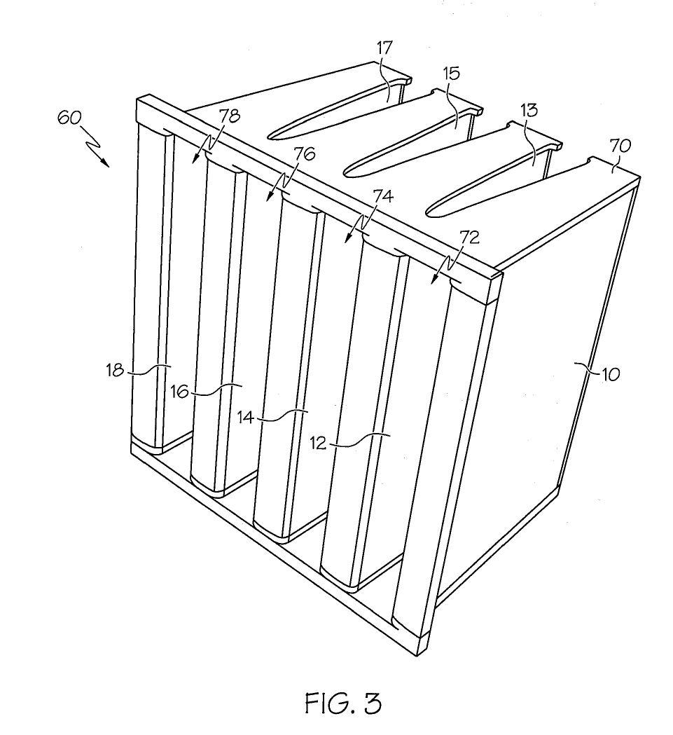

FIG. 1 illustrates an exemplary composite filter element 10 for a filtration system. The composite filter element 10 is configured for filtering fluid, such as liquid, air, or gas, supplied to the filtration system. The composite filter element 10 includes a microglass media 20. As shown within FIG. 2, with the microglass media 20 being part of a composite filter element 10 for filtering fluid, the microglass media 20 has an upstream side 22 and a downstream side 24 for ease of discussion.

In one example, the microglass media 20 is a single layer of microglass fibers. It is contemplated that multiple layers of microglass may be provided within the media 20. A number of different processes can be used to form the microglass media 20. In one example, the microglass media 20 can be formed from a borosilicate microglass fiber medium. The microglass media 20 can also include some other materials. For example, the fibers of the microglass media 20 may be bonded together with acrylate resin and polyvinyl alcohol. Herein after the microglass media 20 is simply referred to as microglass media 20.

The microglass media 20 in the composite filter element 10 can have various physical properties. For example, the glass fibers of the microglass media 20 can have various diameters such as between about 0.3 and 10 microns. The microglass media 20 has a grammage or basis weight of approximately 70 g/m², or in another example between 65 and 75 g/m². This range for the basis weight can correspond to the microglass media having a filtration efficiency rating of approximately a H12 rating, or in another example between approximately 99.5% and 99.93%. The example basis weight can also be larger, such as when an efficiency rating higher than H12 for the microglass media 20 is provided, or can be smaller when an efficiency rating lower than H12 for the microglass media 20 is provided. In one example, the tensile strength of the microglass media 20 is between approximately 0.8 and 1.1 kN/m in the machine direction and between approximately 0.3 and 0.6 kN/m in the cross direction. Also in such an example, the tensile elongation in the machine direction is approximately 1.3 kn/m. The tensile strength and the tensile elongation values provided can correspond to the microglass media having a filtration efficiency rating of approximately a H12 rating, or in another example between approximately 99.5% and 99.93%. The tensile strength and the tensile elongation can also vary based on different efficiency ratings provided for the microglass media 20. The air resistance for the microglass media 20, that can have a filtration efficiency rating of approximately a H12 rating, or in another example between approximately 99.5% and 99.93%, is approximately 210 Pa and in another example as great as 235 Pa at an air resistance of 5.3 cm/s. The air resistance can increase with an efficiency rating higher than H12 or the air resistance can decrease with an efficiency rating lower than H12. The microglass media 20 also has a penetration of 0.1% for 0.3 micrometer aerosol at 5.3 cm/s or for approximately 0.18 micrometer aerosol at 2.5 cm/s. The microglass media 20 also has a penetration between approximately 0.1% and 0.4% for 0.3 micrometer aerosol at 5.3 cm/s or for approximately 0.18 micrometer aerosol at 2.5 cm/s. The penetration values will vary inversely with the filtration efficiency of the microglass media 20. Thus, if a higher filtration efficiency is provided, a lower penetration value will result. The stiffness of the microglass media 20 is between 500 and 750 Gu or mg in the machine direction. The microglass media 20 also can have a hydrostatic head of between 4.5 and 6.5 kPa. Thus, the microglass media 20 can have at least one of the properties described and can also include any combination of the properties described. The properties can also vary beyond the ranges specified depending on the filtration efficiency provided by the microglass media 20.

As also shown in FIG. 1, the composite filter element 10 further includes a scrim 30 along with the microglass media 20. The scrim 30 allows for the passage of fluid from one side to another (e.g., the scrim is relatively open or porous). In one example, the scrim 30 is nonwoven. The scrim 30 can be formed from a variety of materials including polyester, polypropylene, or other polymers. The scrim 30 can have a grammage or basis weight of approximately 30 g/m², or in another example between 25 and 35 g/m². In the example shown within the FIG. 2, only a single scrim 30 is provided and the one scrim is located on the downstream side 24 of the microglass media 20. In another example, the single scrim 30 could be located on the upstream side 22 of the microglass media 20. In yet another example, a second scrim can be added such that a scrim is located on both the upstream side 22 and the downstream side 24 of the microglass media 20.

The scrim 30 can have various dimensions and physical properties. The scrim 30, in one example, has a thickness of approximately 550 microns. In one example, the microglass media 20 is thicker than the scrim 30, and in another example microglass media 20 is thinner than the scrim 30.

The scrim 30 provides rigidity, strength, and support to the microglass media 20 in the substrate. The relatively greater strength of the scrim 30 compensates for a relatively lesser strength of the microglass media 20. Thus, the scrim 30 provides increased strength to the overall composite filter element 10. As fluid passes through the composite filter element 10 and is filtered by the microglass media 20, the scrim 30 provides strength to the composite filter element 10. In terms of function, the scrim 30 can be considered to be an example of means for providing strength.

Rigidity provided by the scrim 30 can permit the composite filter element 10 to be formed and retained in a shape. Accordingly, the microglass media 20 within the composite filter 10 can be formed and retained in the shape. See for example, the formed shape shown within FIG. 1.

The scrim 30 may provide other features. For example, HDPE and nylon mesh have previously been used within a filter element. However, the inclusion of the scrim 30 to the filter element 10 obviates the need for providing such additional structure.

Turning to the overall composite filter element 10, with the microglass media 20 and the scrim 30, the composite filter element can better withstand wet (moist/humid) environments and/or high-pressure environments as compared to the microglass media 20 alone. The composite filter element 10, with the microglass media 20 and the scrim 30, has a better resistance against tearing as compared to the microglass media 20 alone (i.e., if the microglass media 20 alone is placed in a high-pressure and/or wet environment, a higher likelihood of the microglass media 20 being torn exists). Thus, the scrim 30 provides the support and strength to keep the microglass media 20 together even when the composite filter element 10 of the microglass media 20 is placed in these environments. In one example, the scrim 30 is the means that provides the strength to the microglass media 20 of the composite filter element 10 to withstand 25″ Wg (water gauge) without the glass fibers of the microglass media 20 or the composite filter element 10 separating from each other. When the glass fibers separate from each other, the composite filter element 10 starts to fall apart as a significant amount of glass fibers can end up ripping apart from each other. When the glass fibers of the microglass media 20 separate from each other, the microglass media 20 is no longer as useful for filtering the fluid.

The composite filter element 10 can have various dimensions and physical properties. In one example test, the scrim 30 and the microglass media 20 was found to provide tensile strength of between approximately 15-20 N per 15 mm strip in first orientation direction and between approximately 10-15 N per 15 mm strip in the cross direction (as performed according to ISO 1924-2 standard). In one example, the composite filter element 10 can have a thickness of 0.4 mm+/−0.07 millimeters thick at 6.7 N/cm², as measured using the ISO 534 standard. In another example test, composite filter element 10 has a Gurley stiffness of at least 700 mg. The composite filter element 10 can withstand an application of approximately 200 Pa to 280 Pa at 5.3 cm/s. Higher pressures can also be withstood by the composite filter element 10, such as when the composite filter element 10 has a higher filtration efficiency rating. Lower pressures can also be withstood by the composite filter element 10, such as when the composite filter element 10 has a lower filtration efficiency rating. In another example, the composite filter element 10 can provide an air flow resistance of approximately 19 mbar at 400 cm³/s. The composite filter element 10 can have at least one of the properties described and can also include any combination of the properties described.

The composite filter element 10 can also provide a relatively larger basis weight or grammage to provide durability and strength to help withstand the conditions within which the composite filter element 10 is used. The environment can be a wet environment or a high-pressure environment. In one example, the basis weight of the composite filter element 10 with the microglass media 20 and the scrim 30 can be greater than about 90 g/m². In a further example, the basis weight can be in the range between about 90 and about 110 g/m², as measured using the ISO 536 standard.

The composite filter element 10, including the microglass media 20 and the scrim 30, can provide an efficiency of a HEPA rating, such as an H12 rating of greater than or equal to approximately 99.5%, for capturing a particle size of about 0.3 microns, according to the EN 1822 standard for example. A variety of other efficiency ratings from the microglass media 20 and the scrim 30, between about F5 (>50%) and about U17, can also be achieved by selection of various properties for the microglass media 20. In one example, the filtration efficiency rating for a composite filter element 10 can be approximately 99.6% which is slightly better than the H12 rating. This efficiency is measured based on a velocity of 5.3 cm/s providing around 99.6% of a particle capture of approximately 0.3 microns, according to the EN 1822 standard for example. In another example, the filtration efficiency for the composite filter element 10 was measured to be approximately 99.93%, which is slightly below the H13 rating.

Subsequent processes such as corrugating, pleating, and general assembly can also be performed on the composite filter element 10. Corrugating the microglass media 20 provides a large volume of passageways for air flow. For example, corrugations can be formed, such as by corrugating rolls. Example corrugations 40, as shown in FIG. 2, can be configured as an alternating up and down substantially V-shaped wave in a filter element. Wave crests 42 and troughs 44 extend through the microglass media 20. Troughs 44 can have an effective depth D to permit breathability of microglass media 20. In one example, the depth can be approximately 27 mm. A uniform corrugation over the entire cross-section of the filter media can also be provided. A corrugation pitch (repeat frequency) C in the example can be about 8 corrugations per inch.

Alternatively, the composite filter element can have pleats that are formed or retained into a specific orientation. The pleats can similarly have a pitch C and a depth D. Alternatively, different configurations for contouring can be provided for the composite filter element 10.

The composite filter element 10 can be used in a filtration system. The filtration system can include a turbine system, such as at least one gas turbine. The filtration system can be used in various environments, including but not limited to offshore applications, such as marine applications, an oil rig, a naval vessel, or an offshore platform. The composite filter element 10 can also be used in on shore applications, including but not limited to coastal applications, power plants, and areas subjected to high-winds. In addition, the applications on the shore can include exposing the turbines to water, moisture, and/or increased levels of humidity. Furthermore, the composite filter element 10 can also be used in other applications, including but not limited to high-pressure applications. In one example, the composite filter element includes means to withstand a pressure of up to approximately 25″ Wg (water gauge). Without providing a scrim 30, the fibers of the microglass media 20 will more likely than not separate from each other when exposed to this pressure. In another example, the scrim 30 of the composite filter element 10 provides the means to withstand both solids and liquids. An example of a solid that the filter element 10 can withstand is salt. The scrim 30 and the filter element 10 provide the means to restrict or prevent salt contamination from both wet particulate and/or dry salt particulate, at any humidity level, without the glass fibers of the microglass media 20 separating from each other. In yet another example, the scrim 30 of the composite filter element 10 provides the means to withstand salt water or salt from the air, such as from aerosols or misting from the sea or the ocean, without the glass fibers of the microglass media 20 separating from each other. The scrim 30 can also provide the means to withstand up to approximately 25″ Wg (water gauge) while being able to withstand moisture and salt without the glass fibers of the microglass media 20 separating from each other.

In a further example shown in FIG. 3, the at least one composite filter element 10 can be received in a filter cartridge 60 that is used in a filtration system. The filter cartridge 60 can include at least one composite filter element 10. The filter cartridge 60 can have a variety of shapes, sizes, and physical properties corresponding to a desired use and the environment that the filter cartridge 60 is designed to withstand. The filter cartridge 60 in this example includes a plurality of composite filter elements 10, 12, 13, 14, 15, 16, 17, 18 configured for filtering fluid, such as air or gases. The first composite filter element 10, as described with regards to FIG. 1 and FIG. 2, can be representative of each of the other composite filter elements 12, 13, 14, 15, 16, 17, 18. The filter cartridge can include a frame 70. The frame 70 is configured to receive at least one composite filter element 10. The frame 70 can include a plurality of pockets 72, 74, 76, 78. The four pockets 72, 74, 76, 78 in this example correspond to the reception of eight composite filter elements 10, 12, 13, 14, 15, 16, 17, 18. In the first pocket 72, a first composite filter element 10 and a second composite filter element 12 are included on each side of the first pocket 72. The pocket can include approximately 30 m² of microglass media 20. The increased amount of filtration surface area can help to provide a lower pressure drop.

The orientation between the first composite filter element 10 and the second composite filter element 12 can be relatively V-shaped in the first pocket 72. The pockets 72, 74, 76, 78 also can have a variety of shapes, including but not limited to wedge-shaped or V-shaped pockets. In this example, the frame 70 includes a V-cell configuration by having at least one V-shaped pocket with two filter elements where the two filter elements are oriented in a V-shape configuration relative to each other. In an alternative example, the at least one pocket 72 can receive a composite filter element 10 that conforms to the V-shape of the pocket 72. In other examples, the filter cartridge 60 can include different numbers of composite filter elements, including as few as one composite filter element 10. In further examples, the pockets 72, 74, 76, 78 within one filter cartridge have different orientations and shapes. In further examples, a system can be provided that utilizes a plurality of filter cartridges 60 to provide a series of filtration steps and/or to cover a greater surface area. In other examples, the frame 70 can have a variety of shapes, orientations, and pockets, and is not limited to the V-shaped configuration shown in FIG. 1. In an alternative example, the filter cartridge 60 can be part of a bag filter apparatus. A bag filter will provide approximately 5 m² of media, whereas the V-cell configuration will provide 30 m² of media. In this alternative example, the microglass media 20 can be sewn onto the scrim 30. For example, a bag filter with the scrim 30 can be provided in relation to each pocket 72, 74, 76, 78. The bag filter can have four pockets or any other number of pockets.

Methods of manufacturing the composite filter element 10 can incorporate various features of the apparatus as described above. In an example method of manufacturing the composite filter element 10, a microglass media 20 is provided in the at least one composite filter element 10 configured for filtering fluid. A scrim 30, such as a nonwoven scrim, is added during the manufacture of the glass media. The scrim 30 is deposited on the microglass media 20. Different processes can be used to deposit the scrim 30 on the microglass media 20 including but not limited to laminating the scrim 30 on the microglass media 20. The scrim 30 can be laminated to the at least one microglass media 20 to provide additional strength. Alternatively, the scrim 30 can be copleated with the microglass media 20. A frame 70 is provided to support the at least one filter element. The frame 70 can have a variety of shapes and sizes including but not limited to the example of FIG. 3. The at least one composite filter element 10 can be glued or potted to the frame 70. Other adhesives or fasteners can be used to secure or adhere the filter element to the frame 70. In one example, only the outer perimeter of the filter element is provided with adhesive for securing the filter element to the frame 70. In further example, other methods of stabilizing the filter element relative to the frame 70 can be provided without providing any adhesive. Each composite filter element 10 including the microglass media 20 and the scrim 30 can have any of the properties discussed above when produced by the example method, including but not limited to a filtration efficiency of greater than or equal to 99.5%, a basis weight of at least 90 g/m², and/or a tensile strength of between approximately 15-20 N per 15 mm strip in the machine direction and between approximately 10-15 N per 15 mm strip in the cross direction.

The invention has been described with reference to the example embodiments described above. Modifications and alterations will occur to others upon a reading and understanding of this specification. Example embodiments incorporating one or more aspects of the invention are intended to include all such modifications and alterations insofar as they come within the scope of the appended claims.

What is claimed is:

1. A filtration system including:
a composite filter element configured for filtering fluid including:
a microglass media of glass fibers; and
a scrim deposited on the microglass media, wherein the scrim is configured to provide support for the microglass media, and the composite filter element has a filtration efficiency greater than or equal to about 99.5% for capturing a particle size of about 0.3 microns.

2. The filtration system of claim 1, wherein the scrim is located downstream from the microglass media.

3. The filtration system of claim 1, wherein the microglass media and the scrim together have a tensile strength of between approximately 15 to 20 N per 15 mm strip in a machine direction and between approximately 10 to 15 N per 15 mm strip in a cross direction.

4. The filtration system of claim 1, further including a frame configured to receive the composite filter element.

5. The filtration system of claim 4, wherein the frame includes a V-cell configuration that receives the composite filter element.

6. A filtration system including:
at least one composite filter element for filtering fluid including:
a microglass media of glass fibers;
a scrim laminated to the microglass media, wherein the scrim is configured to provide support for the microglass media, and wherein a basis weight of the microglass media and the scrim is at least about 90 g/m²; and
a frame configured to hold the at least one composite filter element;
wherein the frame includes at least one V-shaped pocket that receives the at least one composite filter element.

7. The filtration system of claim 6, wherein the microglass media is pleated.

8. The filtration system of claim 7, wherein the microglass media that is pleated includes pleats with a depth of approximately 27 mm.

9. The filtration system of claim 7, wherein the microglass media that is pleated includes 8 or less pleats per inch.

10. The filtration system of claim 6, wherein the at least one composite filter element has a filtration efficiency that is at least about 50% for capturing a particle size of about 0.3 microns, and wherein a stiffness of the scrim and the microglass media is at least about 700 mg.

11. The filtration system of claim 6, wherein the at least one composite filter element has a filtration efficiency that is at least about 99.5% for capturing a particle size of about 0.3 microns.

12. The filtration system of claim 6, wherein the scrim is located downstream from the microglass media.

13. The filtration system of claim 6, wherein the microglass media and the scrim have a tensile strength of between approximately 15 to 20 N per 15 mm strip in a machine direction and between approximately 10 to 15 N per 15 mm strip in a cross direction.

14. A filtration system including:
a composite filter element configured for filtering fluid including:
a microglass media of glass fibers; and
a scrim deposited to the microglass media, wherein the scrim is configured to provide support for the microglass media, wherein the composite filter element has a filtration efficiency greater than or equal to about 99.5% for a particle size of about 0.3 microns, and
means to withstand approximately 25″ of water gauge pressure without the glass fibers of the microglass media separating from each other.

15. The filtration system according to claim 14, further including a frame configured to receive the composite filter element, wherein the frame includes a V-cell configuration that receives the composite filter element.

16. The filtration system according to claim 14, wherein the microglass media and the scrim have a tensile strength of between approximately 15 to 20 N per 15 mm strip in a machine direction and between approximately 10 to 15 N per 15 mm strip in a cross direction.

17. The filtration system according to claim 14, wherein a basis weight of the microglass media and the scrim is between about 90 g/m²; and about 110 g/m².

18. The filtration system according to claim 14, wherein the means further withstand moisture without the glass fibers of the microglass media separating from each other.

19. The filtration system according to claim 14, wherein the means further restrict salt contamination at any humidity level without the glass fibers of the microglass media separating from each other.
